(19) United States
(12) Patent Application Publication
(10) Pub. No.: US 2023/0299498 A1
(43) Pub. Date: Sep. 21, 2023

(54) Radiation Noise Reduction Component for Use With Information Handling Systems

(71) Applicant: Dell Products L.P., Round Rock, TX (US)

(72) Inventors: Shang-Chu Chien, Taoyuan City (TW); Kun-Da Ho, Taipei (TW)

(73) Assignee: Dell Products L.P., Round Rock, TX (US)

(21) Appl. No.: 17/694,813

(22) Filed: Mar. 15, 2022

(51) Int. Cl. H01Q 17/00; H01Q 7/00

(52) U.S. Cl. CPC H01Q 17/00; H01Q 7/00; H01Q 1/2266

(57) ABSTRACT

A radiation noise reduction component which includes a substrate and a loop antenna mounted on the substrate, the loop antenna being positioned proximate to an energy radiating component of an information handling system, the loop antenna compensating for the radiated energy generated by the energy radiating component.

### BACKGROUND OF THE INVENTION

### Field of the Invention

The present invention relates to information handling systems. More specifically, embodiments of the invention relate to a radiation noise reduction component for an information handling system.

### Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

### SUMMARY OF THE INVENTION

In one embodiment the invention relates to a radiation noise reduction component, comprising: a substrate; and, a loop antenna mounted on the substrate, the loop antenna being positioned proximate to an energy radiating component of an information handling system, the loop antenna compensating for the radiated energy generated by the energy radiating component.

In another embodiment the invention relates to a main housing portion of an information handling system, comprising: a top cover portion; a bottom cover portion coupled to the top cover portion; and, a radiation noise reduction component, comprising a substrate and a loop antenna mounted on the substrate, the loop antenna being positioned proximate to an energy radiating component of the information handling system, the loop antenna compensating for the radiated energy generated by the energy radiating component.

In another embodiment the invention relates to an information handling system comprising: a processor; a data bus coupled to the processor; and an information handling system chassis housing, the housing comprising a base chassis, the base chassis housing the processor, the base chassis comprising a top cover portion; a bottom cover portion coupled to the top cover portion; and, a radiation noise reduction component, comprising a substrate; and, a loop antenna mounted on the substrate, the loop antenna being positioned proximate to an energy radiating component of the information handling system, the loop antenna compensating for the radiated energy generated by the energy radiating component.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 shows a general illustration of components of an information handling system as implemented in the system and method of the present invention.

FIG. 2 shows a perspective view of an example portable information handling system.

FIG. 3 shows a blown-up view of a portable information handling system.

FIG. 4 shows an exploded view of printed circuit board and a radiation noise reduction component.

FIG. 5 shows a cut away top view of a portion of an information handing system in which a radiation noise reduction component is mounted.

FIGS. 6A and 6B, generally referred to herein as FIG. 6, show examples of field distributions with and without a radiation noise reduction component.

FIG. 7 shows an exploded view of printed circuit board and a radiation noise reduction component.

FIG. 8 shows an exploded view of elements of a radiation noise reduction component.

### DETAILED DESCRIPTION

Various aspects of the present disclosure include an appreciation that the chipset, power circuit and related traces of components within an information handling system often radiate energy when operating. This energy can produce unwanted radiated signals which can interfere with device wireless performance. In some cases, this interference can include harmonic clock noise or can cause surrounding components to behave abnormally. It is known to use general mechanical solutions, such as shielding, which can absorb, block or suppress noise radiation. However, often the known solutions may not be able to sufficiently absorb, block or suppress the noise unwanted radiated signals such as when an information system layout presents space limitation. Accordingly, a portable information handling system which includes a radiation noise reduction component is disclosed which addresses these issues.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

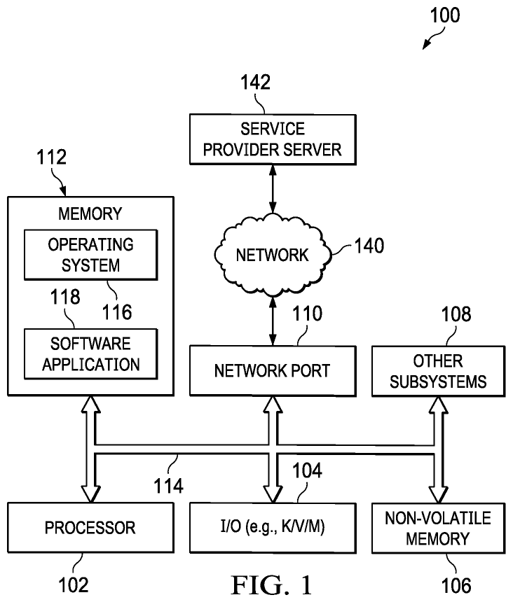

FIG. 1 is a generalized illustration of an information handling system 100 that can be used to implement the system and method of the present invention. The information handling system 100 includes a processor (e.g., central processor unit or “CPU”) 102, input/output (I/O) devices 104, such as a display, a keyboard, a mouse, a touchpad or touchscreen, and associated controllers, a hard drive or disk storage 106, and various other subsystems 108. In various embodiments, the information handling system 100 also includes network port 110 operable to connect to a network 140, which is likewise accessible by a service provider server 142. The information handling system 100 likewise includes system memory 112, which is interconnected to the foregoing via one or more buses 114. System memory 112 further comprises operating system (OS) 116 and in various embodiments may also comprise at least one software application 118. In one embodiment, the information handling system 100 is able to download the software application from the service provider server 142. In another embodiment, the software application 118 is provided as a service from the service provider server 142.

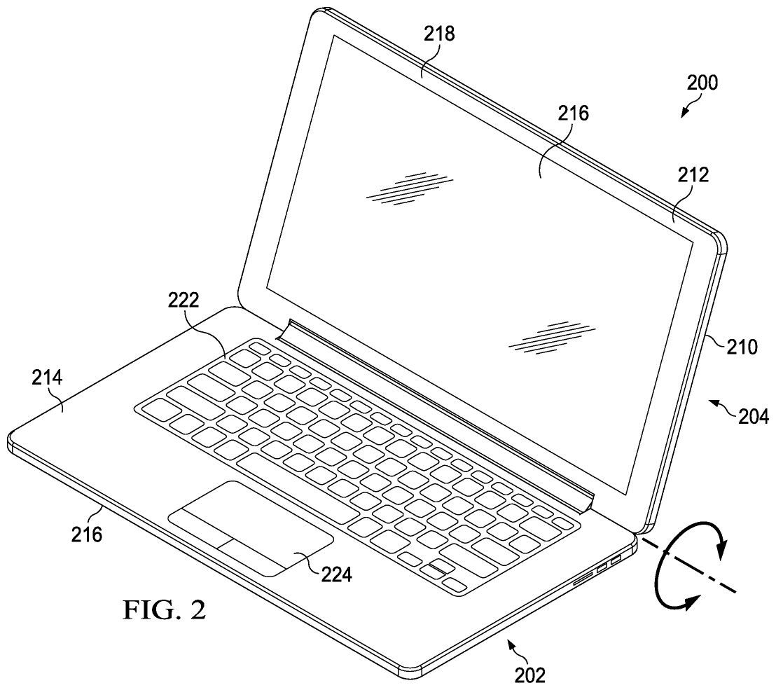

FIG. 2 shows a perspective view of an example portable information handling system chassis 200 such as a tablet type portable information handling system, a laptop type portable information handling system, or any other mobile information handling system. It will be appreciated that some or all of the components of the information handling system 100 may be included within information handling system chassis 200. The portable information handling system 200 chassis includes a base chassis 202 and a display chassis 204 shown in an open configuration. It will be appreciated that a closed configuration would have the display chassis 204 fully closed onto the base chassis 202.

The base chassis 202 or the display chassis 204 of the information handling system 200 may comprise an outer metal case or shell. The information handling system 200 may include a plurality of chassis portions. In various embodiments, the information handling system 200 may include some or all of an A-Cover 210, a B-Cover 212, a C-cover 214 and a D-Cover 216. In various embodiments, the A-Cover 210 and the B-Cover 212 provide the display chassis 204. In various embodiments, the C-Cover 214 and the D-Cover 216 provide the base chassis 202.

In various embodiments, the A-cover 210 encloses a portion of the display chassis 204 of the information handling system 200. In various embodiments, the B-cover 212 encloses another portion of the display chassis 204 of the information handling system 200. In various embodiments, the B-Cover may include a display screen 216 and a bezel 218 around the display screen.

In various embodiments, the C-cover 214 encloses a portion of the base chassis 202 of the information handling system 200. In various embodiments, the C-cover 214 may include, for example, a keyboard 222, a trackpad 224, or other input/output (I/O) device. In various embodiments, certain components of the information handling system such as a mother board are mounted within the C-Cover 214. In various embodiments, the D-cover 216 encloses another portion of the base chassis 202 of the information handling system 200.

When placed in the closed configuration, the A-cover 210 forms a top outer protective shell, or a portion of a lid, for the information handling system 200, while the D-cover 216 forms a bottom outer protective shell, or a portion of a base, for the information handling system. When in the fully closed configuration, the A-cover 210 and the D-cover 216 would be substantially parallel to one another.

In some embodiments, both the A-cover 210 and the D-cover 216 may be comprised entirely of metal. In some embodiments, the A-cover 210 and D-cover 216 may include both metallic and plastic components. For example, plastic components that are radio-frequency (RF) transparent may be used to form a portion of the C-cover 214.

In various embodiments, the display chassis 204 may be movably connected to a back edge of the base chassis 202 via one or more hinges. In this configuration, the hinges allow the display chassis 204 to rotate from and to the base chassis 202 allowing for multiple orientations of the information handling system 200. In various embodiments, the information handling system may include a sensor to detect the orientation of the information handling system and activate or deactivate any number of antenna systems based on the occurrence of any specific orientation. In some embodiments, the information handling system may be a laptop with limited rotation of the display chassis 204 with regard to the base chassis 202, for example up to 1800 rotation arc. In other embodiments the information handling system 200 may be a convertible information handling system with full rotation to a tablet configuration.

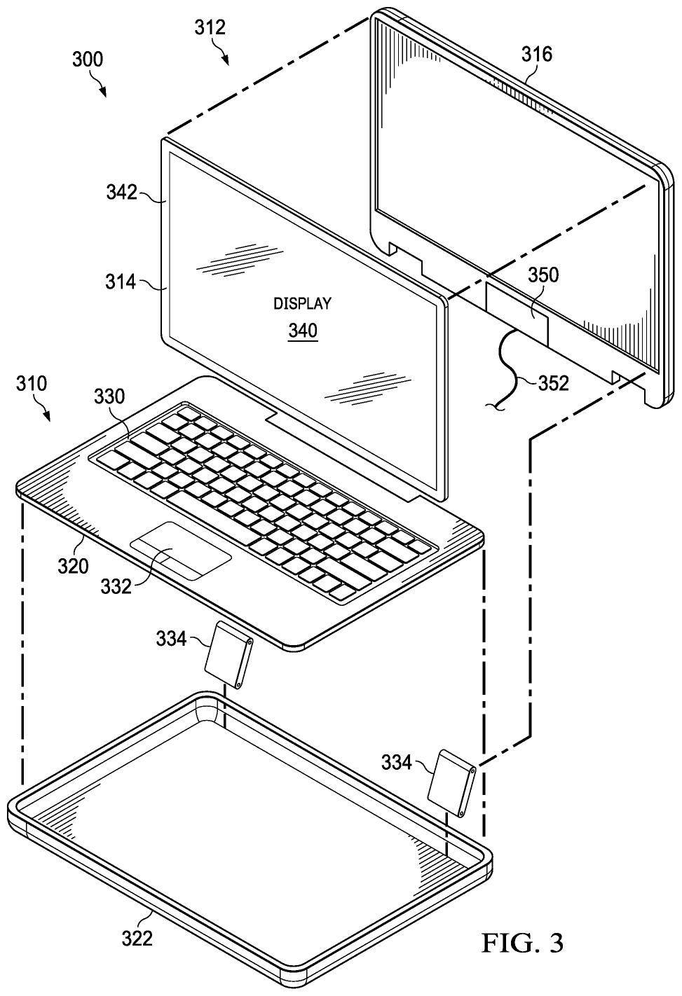

FIG. 3 shows a blown-up view of a portable information handling system 300 having rotationally-coupled housing portions. In the example embodiment, a main housing portion 310 (which corresponds to a base chassis 202) rotationally couples to a lid housing portion 312 (which corresponds to a display chassis 204) to support various configurations to interact with an end user. Main housing portion 310 may hold one or more components of the portable information handling system, including but not limited to processor 102, system bus 114, memory subsystem 112, I/O subsystem 104 and network interface 110 discussed with respect to FIG. 1. Main housing portion 310 includes a top cover portion 320 (which includes the C-Cover 214) and a bottom cover portion 322 (which includes the D-Cover 216). Lid housing portion 312 includes a display cover portion 314 (which includes the B-Cover 212) and a rear display cover portion 316 (which includes the A-Cover 210). The top cover portion 320 may include an integrated keyboard 330 or other I/O devices, such as a trackpad 332 or microphone (not shown). In various embodiments, the keyboard 330 may be mounted to the top of the C-Cover of the main housing portion 310. In various embodiments, the keyboard 330 may be mounted to the underside of the C-Cover of the main housing portion 310.

Lid housing portion 312 is rotationally coupled to main housing portion 310 via at least one hinge assembly 334. Lid housing portion 312 includes display 340 that visually presents information to the user as well as a bezel 342. Display 340 may be a touch panel with circuitry enabling touch functionality in conjunction with a display. In some embodiments, display 340 may be an “infinity edge” or “narrow bezel” display that approaches one or more the edges of lid housing portion 312 such that bezel may be narrow in size (e.g., less than 10 millimeters) on the edges. For example, display 340 is an infinity display with narrow bezels on the top and sides of lid housing portion 312 in the embodiment shown in FIG. 3. In certain embodiments, the side bezel is less than 4 mm (+/−10%) and the top bezel is less than 6 mm (+/−10%).

Lid housing portion 312 may also include timing controller (TCON) 350. Hinge assembly 330 may include cable 352 for communicably coupling one or more components within main housing portion 310 to one or more components within lid housing portion 312. For example, cable 352 may provide communication of graphics information from an I/O subsystem to TCON 350 for generation of visual images for display on display 340. Although a single cable 352 is shown, portable information handling system 300 may include one or more additional cables 352 for communicating components disposed in main housing portion 310 and lid housing portion 312. Placement of cable 352 may be selected based on design considerations, materials or manufacturing cost, material reliability, antenna placement, as well as any other considerations.

Hinge assembly 334 allows main housing portion 310 and lid housing portion 312 to rotate between a plurality of positions. For example, when portable information handling system 300 is not in use, lid housing portion 312 may be closed over the top of main portion 310 such that display 340 and keyboard 330 are protected from unintended use or damage. Rotation of lid housing portion 312 by approximately 90 degrees from main housing portion 310 brings display 340 in a raised “clamshell” position relative to keyboard 330 so that an end user can make inputs to keyboard 330 or touch panel portion of display 340 while viewing display 340. In some embodiments, clamshell position may represent lid housing portion 312 open between approximately 1 and 180 degrees from main housing portion 310. Rotation of lid housing portion 312 between approximately 180 and 359 degrees from main housing portion 310 may place portable information handling system 300 in “tablet stand” and/or “tent” positions. In tablet stand and tent positions, the user may make inputs via touch panel portion of display 340 while viewing display 340. A full 360 degree rotation of main housing portion 310 relative to lid housing portion 312 provides a tablet configuration having display 340 exposed to accept touch inputs. In any position, user inputs may be communicated to an I/O subsystem or a processor of the portable information handling system 300 for processing, and then updated information may be communicated back via cable 352 to display 340 for displaying to the user. Hinge assembly 334 may be comprised of one or more discrete hinges or a unified assembly of hinges.

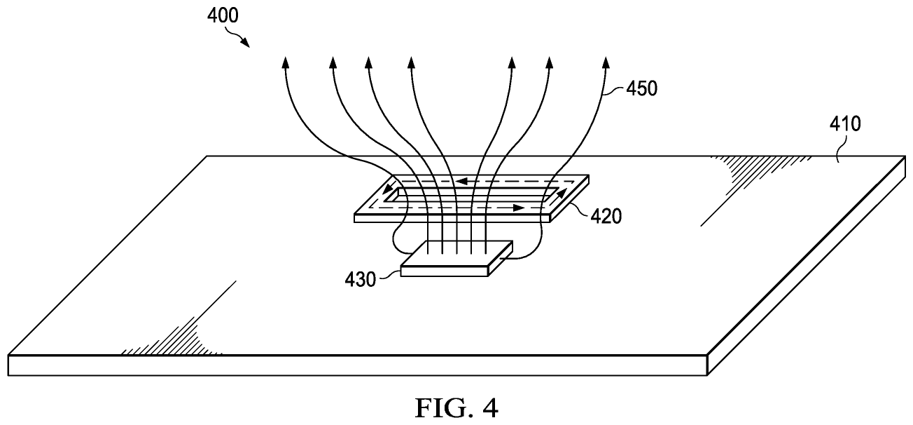

FIG. 4 shows an exploded view 400 of printed circuit board 410 and a radiation noise reduction component 420. In certain embodiments, the printed circuit board 410 is included within an information handling system such as information handling system 100. In certain embodiments, the printed circuit board 410 is included within a base chassis, such as base chassis 202, of a portable information handling system. In certain embodiments, the printed circuit board includes an energy radiating component. In certain embodiments, the energy radiation component includes one or more of a chipset, a power circuit and electrically conductive traces associated with either or both the chipset or the power circuit. In certain embodiments, the chipset include a system on a chip (SOC) type chipset which includes a processor such as processor 102.

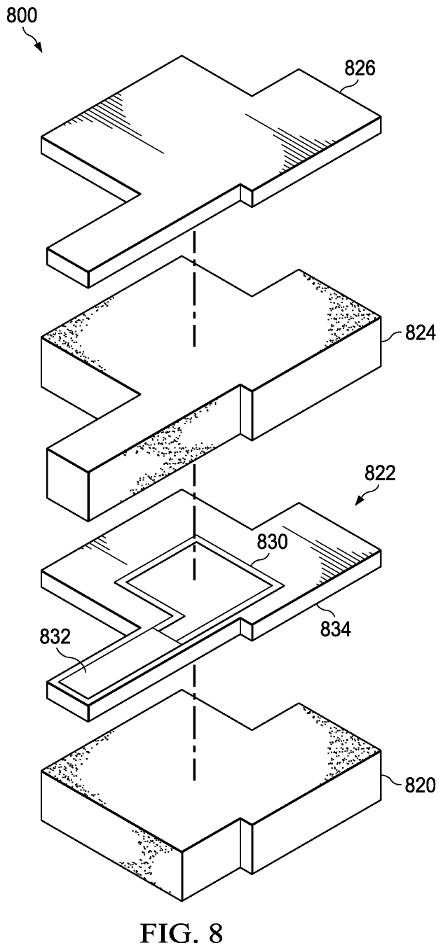

In certain embodiments, the radiation noise reduction component 420 includes a loop antenna which is designed to compensate for the radiated energy generated by the energy radiation component. In certain embodiments, the loop antenna is mounted to a substrate (see e.g., FIG. 8). In certain embodiments, the radiation noise reduction component 420 is electrically coupled to ground. In certain embodiments, the radiation noise reduction component 420 is electrically coupled the ground of the printed circuit board 410. In certain embodiments, the ground of the printed circuit board 410 includes a ground plane. In certain embodiments, the radiation noise reduction component 420 guides the energy radiated energy 450 so that the radiated energy does not interfere with device wireless performance. In certain embodiments, the radiation noise reduction component 420 includes an absorber mounted above the loop antenna relative to the energy radiating component. In certain embodiments, the absorber is configured to have a corresponding frequency response. In certain embodiments, the absorber is configured to have a frequency response that covers a wireless local area network (WLAN) 5 GHz signal. In certain embodiments, the loop antenna of the radiation noise reduction component 420 guides the radiated energy 450 to the absorber which thus enhances the radiation reduction of the radiation reduction component.

In certain embodiments, the loop antenna includes a ½ λ loop antenna (i.e., the wavelength of the loop antenna is configured to be half that of the wavelength of the energy being radiated by the energy radiating component). In certain embodiments, the loop antenna is positioned above the noisy area. In certain embodiments, the loop antenna centralizes the noise through the loop. In certain embodiments, a portion of the radiated noise is coupled to the loop antenna. In certain embodiments, the energy of the noise radiation is coupled by the antenna where the antenna element is designed to a corresponding frequency of noise. It will be appreciated that while the antenna receives energy through radiation, the antenna is not able to absorb 100% noise energy radiation, just a percentage of the noise energy.

The radiation noise reduction component 420 provides an accurate, proactive, and tunable of frequency response noise suppressive solution which enhances noise isolation capability and virtually eliminates any radio frequency interference (RFI) issues related to energy radiation components. In certain embodiments, the radiation noise reduction component 420 facilitates better or more stable wireless performance of the information handling system when compared with previous solutions. In certain embodiments, the radiation noise reduction component 420 provides an extra 5 dB of noise absorbability when compared with certain known solutions. In certain embodiments, the radiation noise reduction component 420 enhances WiFi receiving capability in an office environment by over 45% when compared with certain known solutions. In certain embodiments, the radiation noise reduction component 420 increases WIFi receiving throughput by over 30% by enhancing high attenuation setting usage when compared with certain known solutions. In certain embodiments, the radiation noise reduction component 420 substantially eliminates the impact of HDMI noise on WiFi performance.

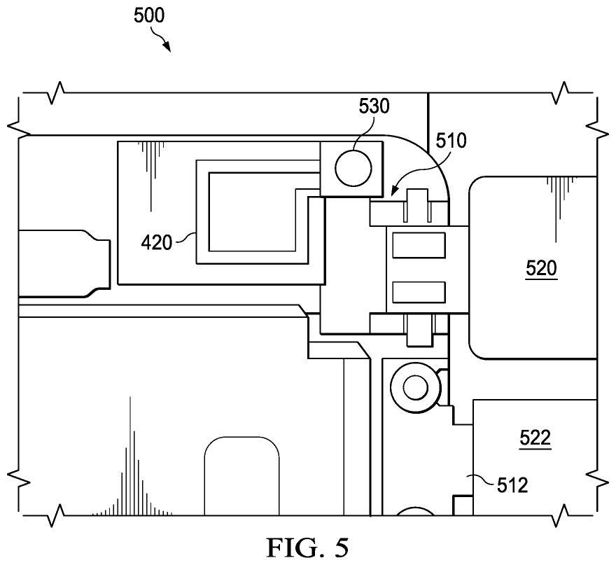

FIG. 5 shows a cut away top view of a portion 500 of an information handing system in which a radiation noise reduction component 420 is mounted. Various aspects of the present disclosure include an appreciation that WiFi performance in certain portable information handling systems is degraded when an HDMI cable is connected to the information handling system.

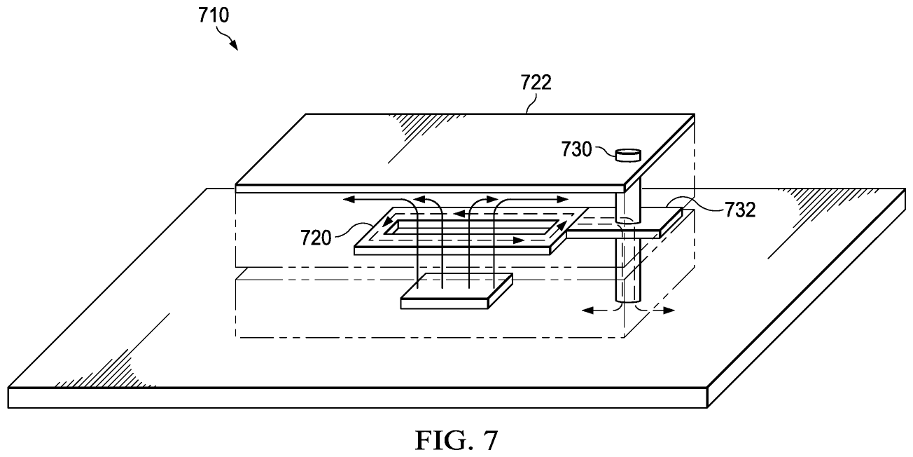

Accordingly, in certain embodiments, a radiation noise reduction component 420 is mounted proximate to an HDMI connector 510 of the information handling system. In certain embodiments, an HDMI cable connector 520 is coupled to the HDMI connector 510. In certain embodiments, the information handling system also includes a USB connector 520 to which a USB cable connector may be coupled. In certain embodiments, an absorber element (see e.g., FIG. 7) is positioned over the loop antenna of the radiation noise reduction component 420. In certain embodiments, the radiation noise reduction component 420 is coupled to ground via a ground connection element 530. In certain embodiments, the radiation noise reduction component reduces a near field scanning level to −73.25 dBm when compared to a level of −55.88 dBm with previous known solutions.

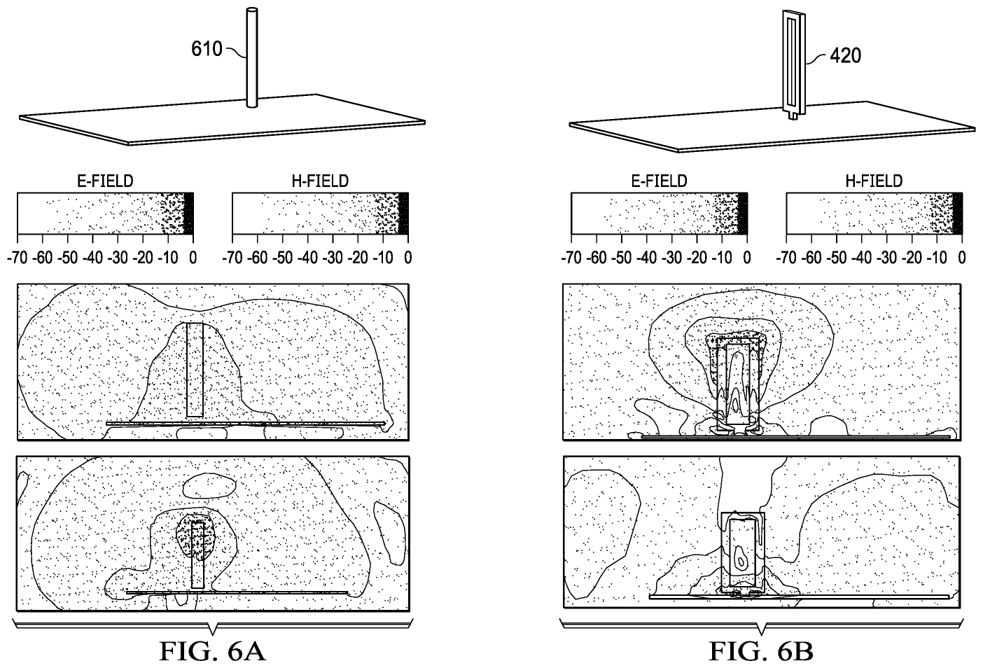

FIG. 6 shows examples of simulations of field distributions with and without a radiation noise reduction component. For example, an electronic field (E-field) distribution is more compressed for the loop antenna of the radiation noise reduction component 420 when compared to the noise source 510 without the radiation noise reduction component. For example, a magnetic field (H-field) distribution is more compressed for the loop antenna of the radiation noise reduction component 420 when compared to the noise source 510 without the radiation noise reduction component. As can be observed in the example field distributions, the radiation noise reduction component causes the noise energy to be centralized by the loop and also to be coupled to the loop.

FIG. 7 shows an exploded view of printed circuit board and a radiation noise reduction component 705. In certain embodiments, the radiation noise reduction component 710 includes a loop antenna 720 as well as an absorber 722 attached above the loop antenna 720 configured to have a corresponding frequency response. In certain embodiments, the loop antenna 720 of the radiation noise reduction component 705 guides the radiated energy to the absorber 722 which thus enhances the radiation reduction of the radiation reduction component 705. In certain embodiments, the loop antenna 720 and the absorber 722 are coupled to ground via a ground connection 730. In certain embodiments, the loop antenna 710 includes a ground tab 732 through which the ground connection 730 passes. In certain embodiments, the loop antenna is electrically coupled to the ground table 732 which is in turn electrically coupled to the ground connection 730. In certain embodiments, the absorber 712 is electrically coupled to the ground connection 730.

FIG. 8 shows an exploded view of elements of a radiation noise reduction component 810. In certain embodiments, the radiation noise reduction component 810 includes one or more of a sponge element 820, a loop antenna element 822, a sponge element 824 and an absorber element 826. In certain embodiments, the sponge element 820 and sponge element 824 are configured with plastic. In certain embodiments, the loop antenna element 822 includes a loop portion 830, a tab portion 832 and a board portion 834 on which the loop portion 832 and the tab portion 832 are mounted. In certain embodiments, the loop antenna element 822 is configured to have a resonant frequency of substantially (e.g., +/−15%) 5.2 GHz.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only and are not exhaustive of the scope of the invention.

Consequently, the invention is intended to be limited only by the spirit and scope of the appended claims, giving full cognizance to equivalents in all respects.

What is claimed is:

1. A radiation noise reduction component, comprising:
a substrate; and,
a loop antenna mounted on the substrate, the loop antenna being positioned proximate to an energy radiating component of an information handling system, the loop antenna compensating for the radiated energy generated by the energy radiating component.

2. The radiation noise reduction component of claim 1, further comprising:
an absorber mounted above the loop antenna relative to the energy radiating component.

3. The radiation noise reduction component of claim 2, wherein:
the absorber has a corresponding frequency response.

4. The radiation noise reduction component of claim 1, wherein:
the loop antenna comprises a ½ λ loop antenna.

5. The radiation noise reduction component of claim 1, wherein:
the energy radiating component comprises at least one of a chipset, a power circuit and electrically conductive traces associated with one or both of the chipset and the power circuit.

6. The radiation noise reduction component of claim 1, wherein:
the radiation noise reduction component is mounted proximate to an HDMI connector of the information handling system.

7. A main housing portion of an information handling system, comprising:
a top cover portion;
a bottom cover portion coupled to the top cover portion; and,
a radiation noise reduction component, comprising
a substrate; and,
a loop antenna mounted on the substrate, the loop antenna being positioned proximate to an energy radiating component of the information handling system, the loop antenna compensating for the radiated energy generated by the energy radiating component.

8. The main housing portion of claim 7, further comprising:
an absorber mounted above the loop antenna relative to the energy radiating component.

9. The main housing portion of claim 8, wherein:
the absorber has a corresponding frequency response.

10. The main housing portion of claim 7, wherein:
the loop antenna comprises a ½ λ loop antenna.

11. The main housing portion of claim 7, wherein:
the energy radiating component comprises at least one of a chipset, a power circuit and electrically conductive traces associated with one or both of the chipset and the power circuit.

12. The main housing portion of claim 7, wherein:
the radiation noise reduction component is mounted proximate to an HDMI connector of the information handling system.

13. An information handling system comprising:
a processor;
a data bus coupled to the processor; and
an information handling system chassis housing, the housing comprising a base chassis, the base chassis housing the processor, the base chassis comprising
a top cover portion;
a bottom cover portion coupled to the top cover portion; and,
a radiation noise reduction component, comprising
a substrate; and,
a loop antenna mounted on the substrate, the loop antenna being positioned proximate to an energy radiating component of the information handling system, the loop antenna compensating for the radiated energy generated by the energy radiating component.

14. The information handling system of claim 13, further comprising:
an absorber mounted above the loop antenna relative to the energy radiating component.

15. The information handling system of claim 14, wherein:
the absorber has a corresponding frequency response.

16. The information handling system of claim 13, wherein:
the loop antenna comprises a ½ λ loop antenna.

17. The information handling system of claim 13, wherein:
the energy radiating component comprises at least one of a chipset, a power circuit and electrically conductive traces associated with one or both of the chipset and the power circuit.

18. The information handling system of claim 13, wherein:
the radiation noise reduction component is mounted proximate to an HDMI connector of the information handling system.
